(19) United States
(12) Patent Application Publication
(10) Pub. No.: US 2012/0107537 A1
(43) Pub. Date: May 3, 2012

(54) HOUSEHOLD APPLIANCE COMPRISING A PANEL

(76) Inventors: Muge Akay, Istanbul (TR); Duygu Bayraktaroglu, Istanbul (TR)

(21) Appl. No.: 13/142,999

(22) PCT Filed: Dec. 14, 2009
(86) PCT No.: PCT/EP09/67098

§ 371 Date: Jan. 20, 2012

(30) Foreign Application Priority Data
Dec. 30, 2008 (TR) A 2008/10037

(51) Int. Cl. B32B 3/10; B32B 33/00; B32B 1/02

(52) U.S. Cl. 428/35.8; 428/203; 428/195.1

(57) ABSTRACT

The present invention relates to a household appliance (1) the panel (3) of which is produced from transparent polymer, onto the rear side of which the metal coating (M) is applied by means of producing the panel (3) from transparent polymer.

The present invention relates to a household appliance comprising a panel.

Household appliances, such as washing machines, dishwashers, dryers, refrigerators, vacuum cleaners, etc., comprise a panel. Display and the buttons on the panel form the interface between the household appliance and the user.

Panels are generally produced from plastic material. Plastic material is preferred since it provides cost advantage and it can be easily shaped compared to the metal material. Bodies of the said household appliances to which the panel is mounted are generally made of metal. In recent years, users prefer that the bodies of the household appliances made of metal are painted gray or remain metallic. In order to make the household appliance visually attractive, the colour of the panels is required to be made harmonized with the metal parts. Producers utilize various techniques to harmonize the colour of the panels produced from plastic material with the gray or metallic body.

In the state of the art, the panels produced from plastic material are painted gray or metallic. Desired performance cannot be obtained in the painted parts during the expected life-span of the production due to the working environment conditions and working conditions.

In the state of the art European Patent Document No EP 0972 485 B1, a control panel used in household appliances, the display frame of which is produced from plastic and coated with metal material, is explained.

The aim of the present invention is the realization of a household appliance comprising a panel produced from plastic which has a harmonic appearance with the body of the household appliance made of metal.

The household appliance realized in order to attain the aim of the present invention is explicated in the attached claims. Printing, such as figures, text, etc., is applied on the rear side of the panel used in the household appliance of the present invention and produced from transparent polymer and the rear side of the panel is coated with metal material.

Polymer material is polycarbonate (PC), polymethylmethacrylate (PMMA), general-purpose polystyrene (GPPS) or styrene acrylonitrile (SAN). The metal coating is aluminum (Al), chromium (Cr) or nickel (Ni). The metal coating is applied onto the panel produced from transparent polymer, using the thermal evaporation or physical vapour deposition (PVD) method.

In an embodiment of the present invention, a protective coating is applied onto the metal coating.

In an embodiment of the present invention, the metal coating is applied on the whole rear side.

In an embodiment of the present invention, the metal coating is applied on the parts of the rear side where there is no printing.

In an embodiment of the present invention, the panel comprises a knob, a handle or a lid, at least one of which is produced from transparent polymer and the rear side of which is coated with metal material (M).

In an embodiment of the present invention, the household appliance comprises a panel which is produced from transparent polymer and the rear side of which is coated, at least partially, with metal material (M).

In the household appliance of the present invention, by coating the rear side of the panel produced from transparent plastic with metal, a low cost panel which is also resistant to the conditions of use is provided to be obtained. Furthermore, since the printing is applied to the rear side of the panel produced from transparent plastic material, the printing is secured throughout the expected life-span of the household appliance.

The household appliance realized in order to attain the aim of the present invention is illustrated in the attached figures, where:

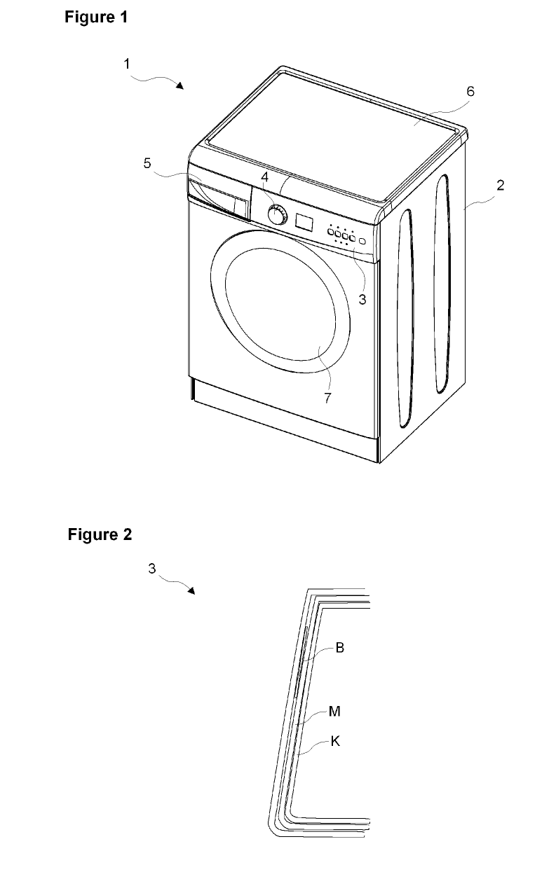

FIG. 1-is the perspective view of a household appliance.

FIG. 2-is the schematic view of the panel.

The elements illustrated in the figures are numbered as follows:

1. Household appliance

2. Body

3. Panel

4. Knob

5. Handle

6. Cover

7. Door

The household appliance (1) of the present invention comprises a body (2) and a panel (3) mounted onto the body (2) (FIG. 1).

The panel (3) is produced from transparent polymer material. Polymer material is polycarbonate (PC), polymethylmethacrylate (PMMA), general-purpose polystyrene (GPPS) or styrene acrylonitrile (SAN).

A printing (B), such as text, figure, logo, etc., is applied on the rear side of the transparent panel (3). Then, coating with metal material (M) is, at least partially, applied on the rear side of the panel (3). By means of producing the panel (3) from transparent material and coating its rear side with metal material, a panel (3) which has a metallic appearance is obtained, and also the metal coating (M) is made resistant to the effects, such as scratching, etc. (FIG. 1 and FIG. 2).

The metal coating (M) is aluminum (Al), chromium (Cr) or nickel (Ni). The metal coating (M) is applied onto the panel (3) produced from transparent polymer, using the thermal evaporation or physical vapour deposition (PVD) method.

In an embodiment of the present invention, a protective coating (K) is applied onto the metal coating (M). The protective coating (K) increases the resistance of the metal coating (M) to the external effects (FIG. 1 and FIG. 2).

In a variation of this embodiment, the protective coating (K) is produced from metal material, such as chromium-nickel alloy and is applied with the physical vapour deposition (PVD) method.

In another variation of this embodiment, the protective coating (K) is an organic paint.

In another embodiment of the present invention, the panel (3) comprises at least a knob (4), a handle (5) and a cover (6) which are mounted thereon. At least one of the knob (4), the handle (5) or the cover (6) is produced from transparent polymer and its rear side is coated with metal material (M).

In an embodiment of the present invention, the metal coating (M) is applied on the whole rear side.

In another embodiment of the present invention, the metal coating (M) is not applied onto the printing (B).

In an embodiment of the present invention, the household appliance (1) comprises a door (7) which enables access to the inside of the body (2). The door (7) is produced from transparent polymer and its rear side is coated, at least partially, with metal material (M).

In the household appliance (1) of the present invention, the metal coating (M) is applied onto the rear side of the panel (3) by means of producing the panel (3) from transparent polymer. Thus, the strength of the metal coating (M) and also of the printing (B) applied to the rear side of the panel (3) are increased.

It is to be understood that the present invention is not limited to the embodiments disclosed above and a person skilled in the art can easily introduce different embodiments. These should be considered within the scope of the protection postulated by the claims of the present invention.

1. A household appliance (1) comprising a body (2) and a panel (3) mounted onto the body (2); characterized by the panel (3)
which is produced from transparent polymer material,
onto the rear side of which a printing (B), such as text, figure, logo, etc., is applied,
the rear side of which is coated with metal material (M).

2. A household appliance as in claim 1, characterized by the panel (3) produced from polycarbonate (PC).

3. A household appliance as in claim 1, characterized by the panel (3) produced from polymethylmethacrylate (PMMA).

4. A household appliance as in claim 1, characterized by the panel (3) produced from general-purpose polystryrene (GPPS).

5. A household appliance as in claim 1, characterized by the panel (3) produced from styrene acrylonitrile (SAN).

6. A household appliance (1) as in any one of the claims 1 to 5, characterized by the metal coating (M) which is aluminum (Al).

7. A household appliance (1) as in any one of the claims 1 to 5, characterized by the metal coating (M) which is chromium (Cr).

8. A household appliance (1) as in any one of the claims 1 to 5, characterized by the metal coating (M) which is nickel (Ni).

9. A household appliance (1) as in any one of the above Claims, characterized by the panel (3) comprising at least one knob (4) which is produced from transparent polymer and the rear side of which is coated with metal material (M).

10. A household appliance (1) as in any one of the above Claims, characterized by the panel (3) comprising at least one handle (5) which is produced from transparent polymer and the rear side of which is coated with metal material (M).

11. A household appliance (1) as in any one of the above Claims, characterized by the panel (3) comprising at least one cover (6) which is produced from transparent polymer and the rear side of which is coated with metal material (M).

12. A household appliance (1) as in any one of the above Claims, characterized by at least one door (7) which enables access to the inside of the body (2), which is produced from transparent polymer and the rear side of which is coated with metal material (M).

13. A household appliance (1) as in any one of the above Claims, characterized by the panel (3), onto the metal coating (M) on the rear side of which a protective coating (K) is applied.

14. A household appliance (1) as in any one of the above Claims, characterized by the panel (3), onto the printing (B) on the rear side of which a metal coating (M) is not applied.

15. A household appliance (1) as in any one of the claims 1 to 13, characterized by the panel (3) onto the whole rear side of which the metal coating (M) is applied.
